(19) United States
(12) Patent Application Publication
(10) Pub. No.: US 2007/0064573 A1
(43) Pub. Date: Mar. 22, 2007

(54) Optical head unit and optical disc apparatus

(76) Inventors: Kazuhiro Nagata, Yokohama-shi (JP); Katsuo Iwata, Yokohama-shi (JP); Hideaki Okano, Yokohama-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/519,996

(22) Filed: Sep. 11, 2006

(30) Foreign Application Priority Data
Sep. 16, 2005 (JP) 2005-270887

(51) Int. Cl. G11B 7/135

(52) U.S. Cl. 369/112.1; 369/112.16

(57) ABSTRACT

According to one embodiment, a diffraction pattern of a diffraction element, or a hologram polarization element, to guide a reflected laser beam divided into a predetermined number to a photodetector is combined preferably as one unit, in order to provide an optical head unit and an optical disc apparatus, which provides a stable reproducing signal, irrespectively of the standards of recording media, when reproducing information from a recording medium of optional standard. By using this diffraction pattern, it is possible to obtain outputs usable to detect first, second and third signals used to detect a tracking error when reproducing information recorded on an optical disc from a reflected laser beam from an optical disc, a fourth signal used to detect a focus error, and a fifth signal used to detect a disc tilt error and a spherical aberration compensating component.

### CROSS-REFERENCE TO RELATED APPLICATIONS

This application is based upon and claims the benefit of priority from Japanese Patent Application No. 2005-270887, filed Sep. 16, 2005, the entire contents of which are incorporated herein by reference.

### BACKGROUND

1. Field

One embodiment of the invention relates to an information recording/reproducing apparatus (optical disc apparatus) which records, reproduces and erases information on/from a recordable, reproduceable and erasable optical disc by using a laser beam, and an optical pickup (optical head) used in the optical disc apparatus.

2. Description of the Related Art

A long time has been passed since the commercialization of an optical disc capable of recording or reproducing information in a noncontact manner by using a laser beam, and an optical disc apparatus (optical disc drive) capable of recording and reproducing information on/from an optical disc (recording medium). Optical discs having several kinds of recording density called CD and DVD have achieved widespread use.

As optical discs of various standards have been developed and used for various purposes, an optical disc recording/reproducing apparatus is required to be capable of recording information on an optical disc of two or more standards, reproducing prerecorded information, and erasing recorded information. Besides, it is demanded as an essential condition of an optical disc recording/reproducing apparatus to be capable of detecting a standard of an optical disc loaded in the apparatus, even if it is difficult to record and erase information.

Therefore, an optical pickup incorporated in an optical disc information recording/reproducing apparatus is required at least to be capable of capturing a reflected ray from a track or a string of recording marks peculiar to an optical disc, and controlling the track and the focus of an object lens (optical pickup), regardless of the standards (types) of an optical disc.

DVD and HD DVD optical discs are different in the pitch in the radial direction of a track, a guide groove, or a string of recording marks, depending on the standards. Therefore, in a track error control to align a laser beam condensed by an object lens with the center of a track or a string of recording marks, a method of dividing a laser beam reflected on an optical disc into a required number of beams by a diffraction element has been widely used to detect a focus error and a tracking error by using a diffraction grating, for example.

For example, Japanese Patent Application Publication (KOKAI) No. 2002-100063 describes a method of reducing an influence of a tracking offset included in the beams of light divided by a diffraction grating, when detecting a focus error by dividing a diffraction grating into several fine areas.

Further, Japanese Patent Application Publication (KOKAI) No. 2004-39165 proposes a method of obtaining a tracking error signal by dividing a reflected ray from an optical information recording medium (an optical disc) into portions where 0^{th} and ±1^{st} diffracted rays are overlapped and not overlapped, applying the reflected ray to independent optical detection means, and obtaining a predetermined signal.

Japanese Patent Application Publication (KOKAI) No. 2005-18894 describes receiving a diffraction light reflected from an optical recording medium, and obtaining a radial tilt amount and a tangential tilt amount.

However, in the method described in Publication No. 2002-100063, the amounts of 2-divided beams of light are made substantially equal by precisely combining two diffraction elements with different diffraction angles, there is a one to one correspondence between the divided areas of a diffraction element and the light-receiving areas of a photodetector. Thus, it is difficult to obtain a signal from the areas with different focus/tracking, or to obtain a signal across the areas. This likely causes the output signal to be buried in noise.

Moreover, the diffraction angle of the ±1^{st} diffracted light of the reflected ray from the optical information recording medium described in above Publication No. 2004-39165 is different according to the wavelength of the reflected light, a track pitch of an optical information recording medium, etc. Therefore, in a pickup unit which receives reflected rays of different wavelengths, reflected rays from tracks of different types of optical information recording medium, or reflected rays when a track with two or more pitches exists in one optical information recording medium, it is impossible to uniquely determine the parts where 0^{th} and ±1^{st} diffracted rays are overlapped and not overlapped.

On the other hand, an optical dividing means based on the wavelength and track pitch of any one reflected ray is difficult to generate a normal track error signal from a reflected ray from optical information recording media with different wavelengths and track pitches. When a track with two or more pitches exists in one optical information recording medium, the system described in the above second Application has a problem that a correct DPD signal is difficult to obtain, because of the influence of zero cross different from that used for a DPD signal.

Even with the optical pickup described in the Publication No. 2005-18894, it is difficult to obtain outputs applicable to the phase difference detection method (DPD) and the push pull method (PP) used for detecting a tracking error when reproducing information recorded on a recording medium, and usable as a compensated tracking error signal (CPP), a focus error signal, a disc tilt error signal (TI), and a spherical aberration compensating signal (SA).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram explaining an example of an optical disc apparatus in accordance with an embodiment of the invention;

FIGS. 2A and 2B are exemplary diagrams each explaining a pattern of dividing a luminous flux by a diffraction element (hologram), and a pattern of a light-receiving area of a photodiode (photodetector), which are incorporated in the optical disc apparatus shown in FIG. 1 in accordance with an embodiment of the invention;

FIG. 3 is an exemplary diagram showing an example of a layout of a light-receiving area of a photodetector incorporated in the optical head shown in FIGS. 2A and 2B in accordance with an embodiment of the invention;

FIG. 4 is an exemplary diagram showing an example of a layout of a light-receiving area of a photodetector incorporated in the optical head shown in FIGS. 2A and 2B in accordance with an embodiment of the invention; and

FIG. 5 is an exemplary diagram showing an example of a layout of a light-receiving area of a photodetector incorporated in the optical head shown in FIGS. 2A and 2B in accordance with an embodiment of the invention.

### DETAILED DESCRIPTION

Various embodiments according to the invention will be described hereinafter with reference to the accompanying drawings. In general, according to one embodiment of the invention, a diffraction pattern of a diffraction element, or a hologram polarization element, to guide a reflected laser beam divided into a predetermined number to a photodetector is combined preferably as one unit, in order to provide an optical head unit and an optical disc apparatus, which provides a stable reproducing signal, irrespectively of the standards of recording media, when reproducing information from a recording medium of optional standard. By using this diffraction pattern, it is possible to obtain outputs usable to detect first, second and third signals used to detect a tracking error when reproducing information recorded on an optical disc from a reflected laser beam from an optical disc, a fourth signal used to detect a focus error, and a fifth signal used to detect a disc tilt error and a spherical aberration compensating component.

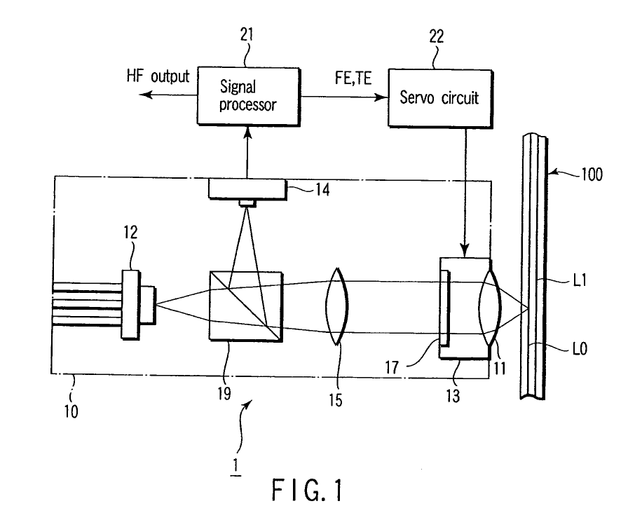

According to an embodiment, FIG. 1 shows an example of an information recording/reproducing apparatus (an optical disc apparatus).

An optical disc apparatus 1 shown in FIG. 1 includes an optical pickup (optical head unit) 10, which can record information in a not shown recording layer, for example, organic film, metallic film or phase-change film, of a recording medium 100 (an optical disc), read information from the recording layer, or erase information recorded in the recording layer. In addition to the optical head unit 10, though not described in detail, the optical disc unit 1 has mechanical elements, such as a not-shown head moving mechanism which moves the optical head unit 10 along the recording surface of an optical disc D, and a disc motor (not shown) which rotates the optical disc D at a predetermined speed. As explained later, the optical disc unit 1 also includes a signal processor to process the output of a photodetector incorporated in the optical head unit 10, and a controller to control the mechanical elements of the optical head unit 10.

The optical head unit 10 includes an object lens 11, which is placed close to the optical disc 100, and captures a laser beam reflected from the recording layer of the optical disc 100, as well as condensing a laser beam from a light source, for example, a laser diode (LD) 12 or a semiconductor laser element, on the recording layer L0 or L1. The wavelength of the laser beam emitted from the laser diode (LD) 12 is 400 to 410 nm, preferably 405 nm.

The laser beam from the laser diode (LD) 12 passes through a polarization beam splitter (PBS) 19 provided at a predetermined position, and is collimated (made parallel) by a collimator lens (CL) 15, and guided to the object lens (OL) 11 through a diffraction element 17, in which an optical dividing element or a hologram plate (hologram optical element (HOE)) is combined with a λ/4 plate (quarter-wavelength plate, or polarization control element).

The laser beam guided to the object lens 11 is given a predetermined convergence by the object lens, and condensed on one of the recording layers L0 and L1 of the optical disc 100. Each of the recording layers L0 and L1 has a guide groove, a track, or a string of record marks (recorded data) formed concentrically or spirally with a pitch of 0.43 to 1.6 μm, for example.

The object lens 11 is made of plastic, and has a numerical aperture NA of 0.65, for example.

The laser beam given a predetermined convergence by the object lens 11 passes through a cover layer of an optical disk (not described in detail), and is condensed on one of the recording layers (or in the vicinity of that layer). (The laser beam from the light source 12 provides a minimum optical spot at the focal position of the object lens 11.)

The object lens 11 (optical head unit 10) is placed at a predetermined position in the direction of track crossing the tracks of each recording layer of the optical disc 100, and at a predetermined position in the direction of focus, or the direction of the thickness of the recording layer, by an object lens driving mechanism (not shown) including a driving coil and a magnet, for example. The position of the object lens 11 is controlled to align a minimum optical spot of a laser beam with the center of a track (a string of recording marks), by moving the object lens 25 in the direction of a track. This is called a tracking control. The position of the object lens 11 is also controlled to make the distance from the object lens 11 to the recording layer identical to the focal distance of the object lens 11, by moving the object lens 11 in the direction of focus. This is called a focus control.

The laser beam reflected on the recording layer L0 or L1 of the optical disc is captured by the object lens 11, converted to a beam having a substantially parallel section, and sent back to the diffraction element 17.

As the diffraction element 17 serves also as a λ/4 plate, the reflected laser beam sent back to the polarization beam splitter 19 through the diffraction element 17 is reflected on the plane of polarization (not described in detail) of the polarization beam splitter 19, because the direction of polarization of the laser beam toward the recording layer of the optical disc 100 is rotated by 90 degrees.

The laser beam reflected on the polarization beam splitter 19 forms an image on the light-receiving surface of the photodiode (photodetector (PD)) 14 by the convergence given by the collimator lens 15. At this time, when passing through the diffraction element 17, the reflected laser beam is divided into a predetermined form and a predetermined number to meet the form and layout of the detection area (light-receiving area) previously given to the light-receiving surface of the photodetector 14.

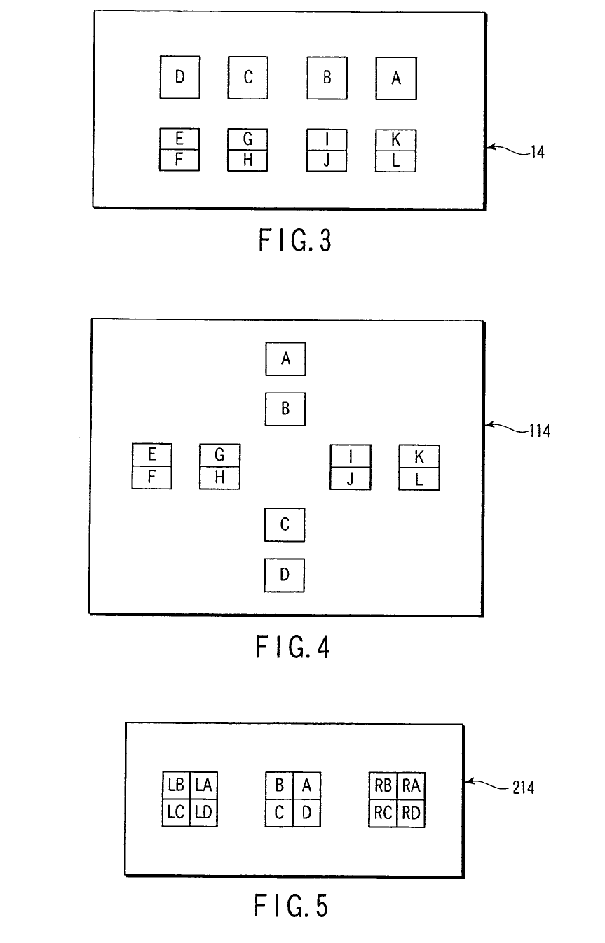

The current output from each light-receiving area (explained later in detail with reference to FIG. 3 to FIG. 5) is converted into a voltage by a not-shown I/V amplifier, and processed to be usable as a HF (reproducing) signal, a track error signal TE, and a focus error signal FE. Though not described in detail, the HF (reproducing) signal is converted to a predetermined signal format, or output to a temporary storage device or an external storage device through a given interface.

The signal obtained by the signal processing circuit 21 is also used as a servo signal to optionally move the object lens 11 of the optical head unit 10 through a servo circuit 22, in the direction (optical axis direction) orthogonal to the plane including the recording surface of the optical disc 100, so that the distance from the object lens 11 to the recording layer L0 or L1 of the optical disc 100 becomes the same as the focal distance of the object lens 11, and in the direction orthogonal to the direction of a track or a recording mark (string of recording marks) previously formed on the recording surface of the optical disc.

The servo signal is generated based on a tracking error signal indicating changes in the position of the object lens 11, according to the well-known focus error detection method, so that an optical spot having a predetermined size at a focal position of the object lens 11 becomes a predetermined size on recording layer L0 or L1 of the optical disc 100; and based on a track error signal indicating changes in the position of the object lens 11, according to the well-known track error detection method, so that the optical spot is guided to substantially the center of a string of record marks or a track.

Namely, the object lens 11 is controlled to provide an optical spot condensed by the object lens 11 in a minimum size on each of the recording layer L0 or L1 of the optical disc 100, at the focal distance, at substantially the center of the track or the string of record marks formed on the recording layer of the optical disc 100.

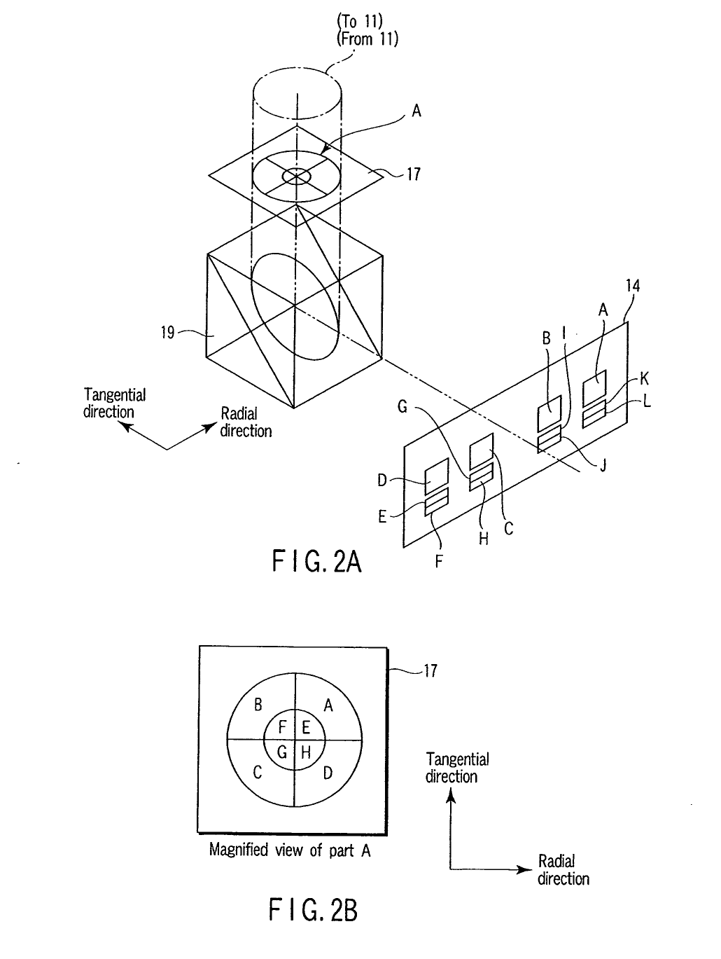

FIGS. 2A and 2B show an example of a pattern of dividing a luminous flux by a hologram element incorporated in the optical head of the optical disc apparatus shown in FIG. 1, and characteristics of layout and form (arrangement pattern) of light-receiving areas of a photodiode (photodetector). FIG. 2B is a magnified view of the part A of FIG. 2A.

As shown in FIGS. 2A and 2B, the diffraction element (HOE combined with the λ/4 plate) 17 has substantially circular patterns formed concentrically, including 8-divided light diffraction areas, as shown in the magnified part A. For example, the outside circle is divided into four areas A to D, and the inside circle is divided into four areas E to H. As shown in FIGS. 2A and 2B, each light diffraction area can diffract the laser beam reflected on optional recording layer of the optical disc 100, in a desired direction to meet the patterns of the light-receiving surface of the photodetector 14 shown in FIG. 3 to FIG. 5. Each light-receiving area (pattern of the light-receiving surface) is divided by the dividing lines along a radial direction orthogonal to the tangential direction and a tangential direction orthogonal to the radial direction of a track, a guide groove or a string of recording marks of the optical disc 100.

The characteristics, such as the form, the ratio of area, the number of divisions and the direction of diffraction, required by the diffraction element 17 can be optionally set by combining with the layout of the light-receiving area of the photodetector 14, as long as the diffraction element can improve the S/N of a tracking error signal obtained by a phase difference detection method (DPD, a first signal detection method)

and a push pull method (PP, a second signal detection method) used to detect a tracking error, when reproducing information recorded on an optical disc having a track with different pitches, and a compensated tracking error signal (CPP, obtained by a third signal detection method); as long as the diffraction element can be used to detect a fourth signal to detect a signal used as a focus error signal, and to detect a fifth signal to detect a signal used as a signal for correction of disc tilt and spherical aberration (disc thickness unevenness); and as long as the diffraction element can detect a reflected beam from an optional recording layer of an optical disc having two or more recording layers.

The size of the boundary circle defined in the diffraction element 17 shown as the magnified part A in FIG. 2B is determined based on the pitch of the guide groove (track) previously formed on the recording surface of an optical disc (recording medium) reproducible by the optical disc apparatus 1.

When a reproducible optical disc is of a common DVD standard, for example, the track pitch is 0.68 μm, for example.

If a reproducible optical disc is of a HD DVD standard with the recording density higher than a current DVD standard optical disc, the track pitch in the track of data area is 0.3 to 0.7 μm, for example, 0.34 to 0.44 μm, typically 0.40 μm in many cases. In an optical disc of HD DVD standard, the track pitch in a system lead-in area is set to 0.68 μm.

Therefore, although not shown in the drawing, the diameters of the concentric boundary circles of the diffraction element shown in FIG. 2 are defined in the area which includes the area where diffracted rays of a laser beam reflected from a track with a wide pitch (e.g., 0.8 μm) are overlapped, and include no diffracted rays of a laser beam reflected from a track with a narrow pitch (e.g., 0.40 μm).

The characteristics required by the diffraction element 17 shown magnified as the part A in FIG. 2 are not particularly restricted, as long as the diffraction element can divide a reflected ray from an optionally recording layer of the optical disc 100, so that the luminous flux at the center of the reflected ray (the main light beam, or the component passing through substantially the center of the object lens 11) coincides with the center of division, at least in the radial and tangential directions. Making the diffraction element as concentric circles is useful for generating a light beam, which is divided at a predetermined distance (radius) from the center of the divisions in the radial and tangential directions (for the compensated push-pull [TE], tilt detection, or spherical aberration correction).

For example, a first focus error (FE) signal can be generated by the well-known knife edge method by using the light diffracted by the pattern inside the boundary circle (defining the area of the inside circle), and a second focus error) (FE) signal can be generated by the knife edge method by using the light diffracted by the pattern outside the boundary circle, and SA (a spherical aberration correcting signal) explained hereinafter can be obtained by using the difference between the obtained focus error signals.

FIG. 3 shows a detailed pattern of a light-receiving area of the photodetector 14. The diffracting direction of each light beam diffracted by the diffraction element 17 and guided to each light-receiving area of the photodetector can be optionally defined as described above.

As a signal obtained by combining the output of each light-receiving area of the photodetector 14, there are

Focus error signal FE (by the double knife edge method),

Tracking error signal PP by the push-pull method,

Tracking error signal DPD by the phase difference detection method,

Tracking error signal CPP by the compensated track error (compensated push-pull method) considering the influence of the lens shift of the object lens 11,

Tilt error signal (TI, or Tilt), and

Spherical Aberration Error Signal (SA)

Assuming the outputs from the light-receiving areas A to H of the photodetector 14 to be SA to SH, these signals are obtained by
FE=(SI−SJ)+(SL−SK), or
(SE−SF)+(SG−SH),
PP(TE)=(SA+SB)−(SI+SJ+SK+SL), or
(SC+SD)−(SE+SF+SG+SH),
DPD(TE)=ph(SA+SI+SJ)−ph(SB+SK+SL), or
pH(SD+SG+SH)−ph(SC+SE+SF),
CPP(TE)=(SA+SB)−(SI+SJ+SK+SL)−k[(SC+SD)−(SE+SF+SG+SH)]

k is an optional constant (a correction coefficient determined based on the factors, such as the wavelength and intensity of a laser beam from a light source, and the divisions of an area of a diffraction element, and either positive or negative), or
(SC+SD)−(SE+SF+SG+SH)−k[(SA+SB)−(SI+SJ+SK+SL)],
T(Tilt)=SA, SB, I+J, K+L, or
SC, SD, G+H, E+F

. . . (each of radial and tangential)

and,
SA=(SI−S)+(SL−SK), and
(SE−SF)+(SG−SH)

Since the difference between the examples shown in FIG. 3 and FIG. 4 is the position and direction of the light-receiving area A to D, except the 2-divided light-receiving areas, various photodetectors can be easily designed simply by appropriately setting the diffracting directions caused by the area A to H of the diffraction element 17 shown magnified as the part A in FIG. 2.

Further, by preparing three blocks of detection area, each consisting of four areas A to D (and LA to LD and RA to RD for discrimination purposes), and giving total 12 detection areas, as shown in FIG. 5, the same output as the photodetector shown in FIG. 3 or FIG. 4 can be obtained. Namely, By corresponding LA to LD or RA to RD to E to H or I to L shown in FIG. 3 or FIG. 4, the same signal can be obtained.

As explained hereinbefore, by using the light-receiving optical system defined by the invention, it is possible to improve the signal to noise ratio of a tracking error signal (PP) obtained by the push-pull method and a tracking error signal (DPD) obtained by the phase difference detection method, used to detect a tracking error when reproducing information recorded on an optical disc (recording medium) having a track with two or more different pitches, and a compensated tracking error signal (CPP); and it is possible to easily obtain various signals usable for detection of signals for correction of focus error, disc tilt and spherical aberration (disc thickness unevenness). The characteristics of the diffraction element, such as the diffraction pattern, the number of divisions and the direction of diffraction, can be easily set. Namely, it is possible to provide a photodetector which can take out a preferable reflected ray from optical discs of various standards (types) according to the kinds of signal to be extracted, and it is possible to define a diffraction pattern of an optical diffraction element, or a hologram polarization element, to guide a reflected laser beam divided into a predetermined number, to the photodetector. Therefore, it is possible to simplify a layout pattern of a light-detecting area of a photodetector to extract a signal from a reflected laser beam from an optical disc, according to the types and standards of the optical disc.

As explained here, according to the invention, a diffraction pattern of a diffraction element to guide an optional number of reflected laser beams divided into a predetermined number to a photodetector is combined preferably as one unit, and it is easy to design an optical head unit to obtain a focus error signal, a track error signal, a track error signal for correction (in a system with a lens shift), and a reproducing signal (RF), from a reflected laser beam from an optical disc.

Particularly, when reproducing a signal from various optical discs with different pitches of a track or a string of recording marks peculiar to each optical disc, it is possible to obtain an optical head difficult to be influenced by the pitches of a track or a string of recording marks.

Namely, it is unnecessary to completely divide an area of a reflected ray from a recording medium (an optical disc) for FE (detection of a focus error), TE (detection of a track error), etc., and the flexibility of designing an optical head unit is enlarged. Further, an optical head unit is easily applicable to several types of recording medium, and particularly a three-wavelength compatible optical head unit can be easily configured.

Therefore, an optical head unit and an optical disc apparatus with stable characteristics can be obtained at low cost.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical head unit comprising:
a diffraction element which has a diffraction area
defined to divide a reflected ray from a recording medium into at least four beams, including a main light beam (center luminous flux) of the reflected ray, in each of a radial direction of a recording medium and a tangential direction orthogonal to the radial direction; and
a photodetector which receives each light component divided by the diffraction element, and outputs a signal corresponding to the intensity of the light.

2. The optical head unit according to claim 1, wherein the diffraction element includes eight diffraction areas divided concentrically with the center of divisions in the radial and tangential directions.

3. The optical head unit according to claim 1, wherein the photodetector has at least eight light-detecting areas, and by combining processing such as addition, subtraction and constant multiplication of an output signal obtained from each light-detecting area, outputs a signal usable for at least one of first and second signal detection methods used to detect a tracking error when reproducing information recorded on a recording medium, and a third signal detection method used to detect a signal used as a compensated tracking error signal, a fourth signal detection method to detect a signal used as a focus error signal, and a fifth signal detection method to detect a signal used as a disc tilt error signal and a spherical aberration compensating signal.

4. The optical head unit according to claim 1, wherein the photodetector has at least eight light-detecting areas, and by combining processing such as addition, subtraction and constant multiplication of an output signal obtained from each light-detecting area, outputs a signal usable for at least one of first and second signal detection methods used to detect a tracking error when reproducing information recorded on a recording medium, and a third signal detection method used to detect a signal used as a compensated tracking error signal, a fourth signal detection method to detect a signal used as a focus error signal, and a fifth signal detection method to detect a signal used as a disc tilt error signal and a spherical aberration compensating signal.

5. The optical head unit according to claim 1, wherein the four central areas of the concentrically divided diffraction areas of the diffraction element are used to generate diffraction components for the first, third and fifth signals, which are the signals output from the light-detecting areas of the photodetector.

6. The optical head unit according to claim 5, wherein the photodetector has at least eight light-detecting areas, and by combining processing such as addition, subtraction and constant multiplication of an output signal obtained from each light-detecting area, outputs signals usable as signals to detect the first, second and third signals used to detect a tracking error when reproducing information recorded on a recording medium, a fourth signal used to detect a focus error signal, and a fifth signal used to detect a disc tilt error signal and a spherical aberration compensating component.

7. An optical disc apparatus comprising:
a diffraction element which has a diffraction area
defined to divide a reflected ray from a recording medium into at least four beams, including a main light beam (center luminous flux) of the reflected ray, in each of a radial direction of a recording medium and a tangential direction orthogonal to the radial direction;
a photodetector which receives each light components divided by the diffraction element, and outputs a signal corresponding to the intensity of the light;
a signal output unit which generates, based on the outputs from the light-receiving areas of the photodetector, a signal usable for at least one of first and second signal detection methods used to detect a tracking error when reproducing information recorded on a recording medium, and a third signal detection method used to detect a signal used as a compensated tracking error signal, a fourth signal used to generate a signal used as a focus error signal, and a fifth signal used to generate a disc tilt error signal and a spherical aberration compensating signal; and
an information reproducing unit which obtains a reproducing output to reproduce information recorded on a recording medium, by using the output from at least one of the light-receiving areas of the photodetector.

8. The optical disc apparatus according to claim 7, wherein the photodetector has at least eight light-detecting areas, and by combining processing such as addition, subtraction and constant multiplication of an output signal obtained from each light-detecting area, outputs a signal usable for at least one of first and second signal detection methods used to detect a tracking error when reproducing information recorded on a recording medium, a third signal detection method used to detect a signal used as a compensated tracking error signal, a fourth signal detection method to detect a signal used as a focus error signal, and a
fifth signal detection method to detect a signal used as a disc tilt error signal and a spherical aberration compensating signal.

9. An optical disc apparatus comprising:
a diffraction element which has a diffraction area
defined to divide a reflected ray from a recording medium into at least four beams, including a main light beam (center luminous flux) of the reflected ray, in each of a radial direction of a recording medium and a tangential direction orthogonal to the radial direction;
a photodetector which receives each light component divided by the diffraction element, and outputs a signal corresponding to the intensity of the light; and
an information reproducing unit which obtains a reproducing output to reproduce information recorded on a recording medium, by using the output from at least one of the light-receiving areas of the photodetector.
